(19) United States
(12) Patent Application Publication
(10) Pub. No.: US 2003/0167797 A1
(43) Pub. Date: Sep. 11, 2003

(54) Shaped body and production method thereof

(76) Inventors: Hermann Schmid, Aalen (DE); Holger Gödeke, Achstetten (DE)

Correspondence Address: Barnes & Thornburg, 11 South Meridian Street, Indianapolis, IN, 46204, US

(21) Appl. No.: 10/258,929

(22) PCT Filed: Apr. 18, 2001
(86) PCT No.: PCT/EP01/04372

(30) Foreign Application Priority Data
Apr. 28, 2000 (DE) 100 20 955.6

(51) Int. Cl. C03B 19/08

(52) U.S. Cl. 65/22; 428/426

(57) ABSTRACT

The invention relates to a shaped body and a method for producing such shaped bodies which have substantially more favourable physical and chemical properties and which can be used advantageously thereby in the most varied of application fields, particularly in the construction industry. The shaped bodies should be produced at low cost and higher strengths should be achieved than conventional materials, with as low bulk densities as possible. According to the invention, this object is achieved in that the shaped body is formed exclusively from lightweight aggregates which are sintered together. The lightweight aggregates are selected thereby from expanded glass granulate, expanded clay granulate, or thermally pre-expanded perlite or also from mixtures thereof. They are produced from the lightweight aggregate in granulate form, having a residual expanding agent content of at least 0.1% by mass. The lightweight aggregate is heated in a mould, temperatures above the softening temperature of the granulate being achieved. The result is then a further expansion in volume and the sintering of the granulate surfaces and the shaped body can then be removed from the mould.

The invention relates to a shaped body and a method for producing such shaped bodies. The correspondingly produced shaped bodies are suitable for the most varied of application fields and here in particular in the construction industry because of favourable physical and chemical properties.

In the building material sector, ever higher requirements are placed on the building materials and building elements which are used. This concerns in particular lightweight construction, heat insulation and sound insulation, resistance to chemical and physical effects and also environmental compatibility.

In particular because of the first-mentioned reasons, lightweight aggregates are used which are intended quite particularly to have a mass-reducing effect. The density and consequently also the corresponding mass cannot thereby always be reduced below specific limits in the case of conventionally used materials since then the required strengths are no longer offered.

For the bond during production of corresponding building elements, the lightweight aggregates are mixed with organic or inorganic (for example water glass) binders and the desired properties are in fact improved but the desired level can still not always be achieved.

When using binding or sintering aids, a mass is produced as intermediate product, which requires a significant technological complexity for its processing and shaping. Thus, filling the form tools with this mass, the consistency of which is comparable to wet sand, turns out to be very labour intensive, the processing procedure not being able to be automated. Furthermore, the binders incur not only considerable additional costs, but frequently material composites are produced which are not recyclable.

A shaped body made of lightweight material is thus known in DE 197 12 835, in which a network-like bond is intended to be achieved by means of a liquid phase sintering of a mixture comprising expanded glass, perlite or expanded clay with soda water glass. Such a formed body is produced as a result of the fact that the correspondingly chosen lightweight aggregate and the binder (soda water glass) are mixed, subjected to a shaping process and sintered at temperatures in the range of 550° C. to 1000° C. so that the network-like bond is formed essentially from soda lime glass as a result of liquid phase sintering.

In each case, an increase in density occurs with the conventionally used binding or sintering aids, thus also a corresponding increase in mass in the case of identically formatted building elements.

A shaped body produced according to DE 197 12 835 A1 has an open-pored structure which presents in fact advantages with respect to the desired acoustic properties, however the remaining pores, in addition to there being less strength, can also absorb and store moisture, which frequently has a disturbing effect.

It is therefore the object of the invention to produce, with greatly reduced complexity, shaped bodies which can achieve higher strengths with bulk densities which are as small as possible.

According to the invention, this object is achieved with a shaped body according to claim 1 and a method for producing such a shaped body according to claim 4. Advantageous embodiments and developments are achievable with the features contained in the subordinate claims.

The shaped body according to the invention comprises a lightweight aggregate selected from expanded glass, expanded clay or thermally pre-expanded perlite, without the normal binding or sintering aids continuing to be contained. Said shaped body is formed from the respective lightweight aggregate which is sintered together and thus a relatively light shaped body with a relatively low bulk density but with higher strength can be obtained. The lightweight aggregate which is sintered according to the invention has before sintering a residual expanding agent content of 0.1-1% by mass, preferably up to 0.5% by mass. In the case of gaseous expanding agents, residual contents of 0.1 to 95% by volume can occur. The shaped body according to the invention represents a closed-pore structure or such a structure, for example in contrast to the shaped body known from DE 197 12 835 A1. There can be achieved a bulk density ≦500 kg/m³ up to bulk densities in the range of 180 kg/m³ with compression strengths of approximately 1.6 N/mm², flexural strengths of approximately 0.9 N/mm² and tensile strengths of approximately 0.2 N/mm².

The starter granulate can be used with particle sizes in the range of 0.25 to 8 mm.

The shaped body according to the invention has a low heat conductivity, is not combustible, is resistant to acids and bases, is dimensionally stable, resistant to rodent attack and is safely recyclable. It absorbs virtually no moisture and can therefore be used more favourably in many cases in the building material sector than is possible with conventional building materials or building elements.

Relative to the shaped body, known from DE 197 12 835 A1, a bulk density reduced by approximately a third can be achieved and the strength can likewise be increased by a third.

When producing the shaped bodies according to the invention, the procedure is such that preferably closed-pore pre-expanded expanded glass- or expanded clay granulate are used as lightweight aggregate, a residual expanding agent content of at least 0.1% by mass being intended to be contained in every case. A partly expanded granulate of this type can be obtained such that, by means of a corresponding process control, the thermally induced expanding process of the starter granulate is not concluded and hence expanding agent is initially not completely converted. This can occur for example by means of shorter temperature treatment. By using a granulate composition which has only a low temperature dependency upon the viscosity above the softening temperature, then a predominantly closed-pore granulate can be obtained which has a correspondingly increased residual expanding agent content. The expanding agent can release gases, such as for example CO₂, under the effect of heat, for instance also during sintering and subsequent expansion.

The thus prepared, flowable, mixed granulate is poured into a temperature-resistant mould, is compressed and heated. These granulate bulk materials are thereby tempered up to a temperature above the softening temperature. Because of the expanding agents which are still available, the internal pressure in the pore spaces of the granulates is increased during softening, which leads to subsequent expansion of the granulates and hence produces an additional expansion in volume. At the same time, the individual granulates sinter at the contact points, the surfaces enlarging conditioned by the expansion in volume. The enlargement of the contact faces leads on the one hand to an increase in the intergranular binding forces and on the other hand reduces the open pore space. During production, a homogeneous temperature distribution should be observed in order to achieve a uniform pore structure. Since the pre-expanded starter granulate further experiences an increase in volume due to the heating, it is favourable to fill the mould with the starter granulate only with a proportion of the volume of at least 80% and at most 95%, preferably with at least 85% by volume. As a result, a closed-pore structure can be obtained during heating; the closed-pore component should be at least 75%, preferably more than 90%.

The invention is intended to be explained subsequently with reference to an embodiment.

There are shown thereby:

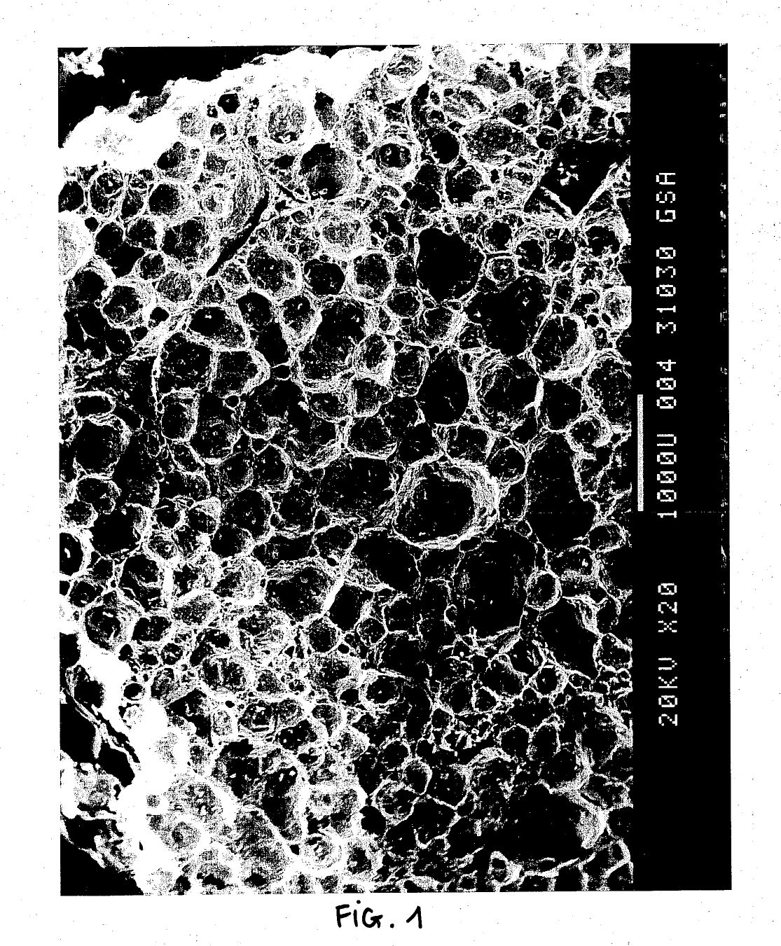

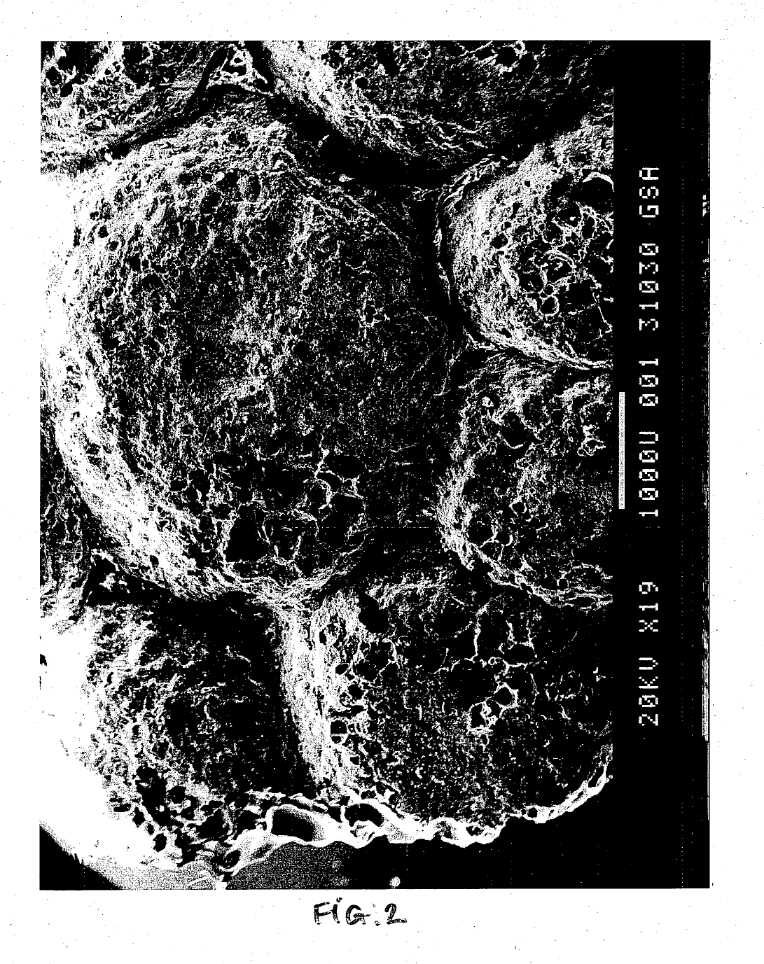

FIGS. 1 and 2 scanning electron micrograph of sintered individual granulates in various enlargements and

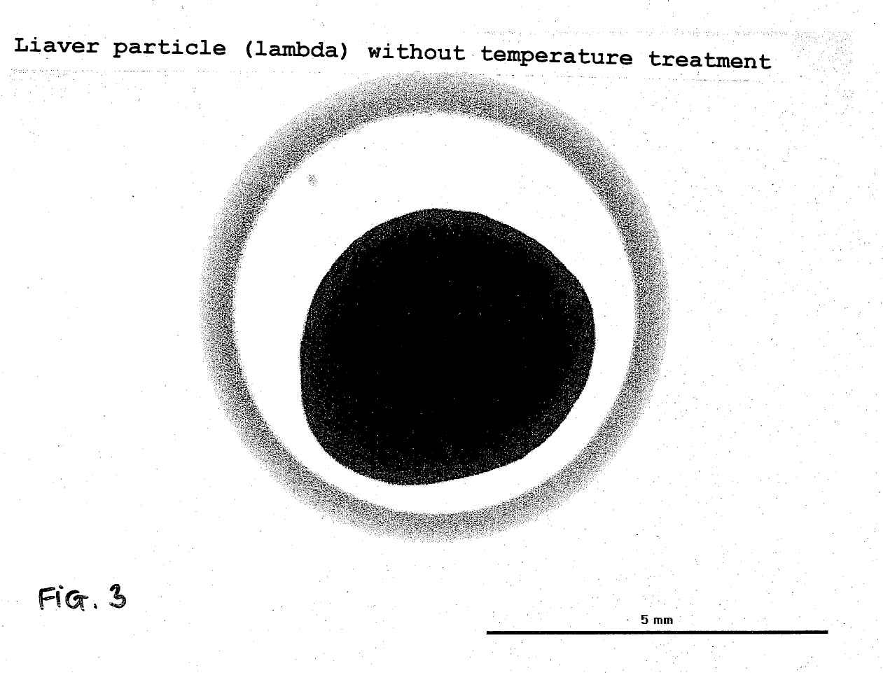

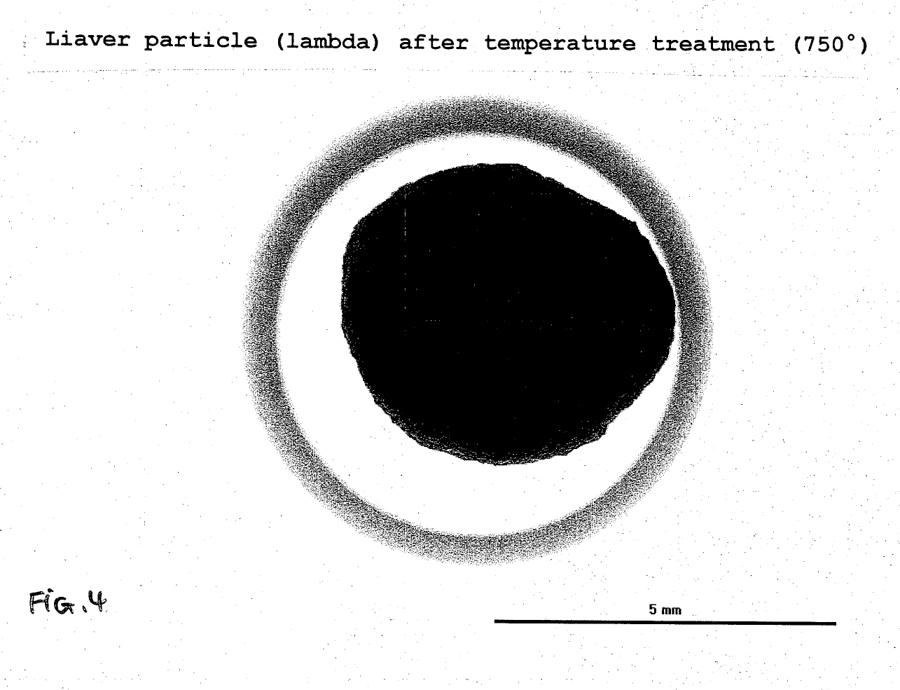

FIGS. 3 and 4 an individual starter particle before and after temperature treatment.

A shaped body made of an expanded glass granulate, which is commercially available with the trade description “Liaver” and is described by way of example in EP 0 661 240 B1, is thereby used. Such an expanded glass granulate is placed in at an least two-part stainless steel mould with the dimensions 740×420×50, the internal wall of which is provided with an inorganic mould-releasing agent. 3.5 kg expanding glass granulate with a particle size between 2 to 4 mm is thereby used, the residual carbon content of which is approximately 2.5 g/kg. After filling, the bulk material is equalised in the mould by shaking so that a uniform filling level is achieved.

Heating takes place after filling, there being intended a heating rate in a first heating stage of 5 K/min to 650° C. and after achieving this temperature then subsequently a heating rate of 2 K/min to a final temperature of approximately 750° C. If the softening temperature of the expanded glass granulate is achieved, this is maintained over a period of 0.5 h, the result being in addition to the further expansion in volume, sintering of the granulates whilst forming a predominantly closed-pore structure. With favourable temperature control, a foam structure can be obtained in which the original particle boundaries of the granulates are no longer detectable.

The heating can be implemented in a discontinuous batch furnace or in a continuously operated sliding batt kiln.

Subsequent to the heating and maintaining at temperature, the finished shaped body can be removed from the mould after cooling which expediently can reach ambient temperature over a period of one hour. After removing from the mould, the shaped bodies can be sawn to size by cutting.

Scanning electron micrographs are shown in FIGS. 1 and 2 in various enlargements which make clear the closed-pore structure.

FIGS. 3 and 4 show an individual particle before and after temperature treatment.

Table 1 presents data of an image-analytical evaluation for a comparison of starter granulate before temperature treatment and thereafter.

TABLE 1

| | | Surface | | |
|---|---|---|---|---|
| Liaver | Surface RT | 750° C. | Difference | |
| Particle No. | mm² | mm² | mm² | % |
| 0 | 11.9 | 13.8 | 1.8 | 15.4 |
| 1 | 16.1 | 18.8 | 2.7 | 16.8 |
| 2 | 16.4 | 18.8 | 2.4 | 14.9 |
| 3 | 10.4 | 12.2 | 1.8 | 17.2 |
| 5 | 16.9 | 20.7 | 3.8 | 22.2 |
| 6 | 13.8 | 16.5 | 2.6 | 19.0 |
| 7 | 13.9 | 16.4 | 2.6 | 18.5 |
| 8 | 11.5 | 13.5 | 2.1 | 18.0 |
| 9 | 96 | 11.8 | 2.2 | 23.1 |

A shaped body produced in this manner achieves the properties which can be deduced from Table 2.

TABLE 2

| Property | Unit | Value |
|---|---|---|
| Bulk density | kg/m³ | 180 |
| Compression strength | N/mm² | 1.6 |
| Flexural strength | N/mm² | 0.9 |
| Tensile strength | N/mm² | 0.2 |
| Heat conductivity | W/mK | 0.06 |
| Flow resistance | kPas/m² | 200 |
| Acoustic absorption factor | | <0.4 |

1. Shaped body,
characterised in that it is formed exclusively from expanded glass granulate which is sintered together, the expanded glass aggregate comprising a residual expanding agent content of 0.1 to 1% by mass before sintering and the granulate having a predominantly closed-pore structure.

2. Shaped body according to claim 1,
characterised in that it has a bulk density which is less than 500 kg/m³.

3. Method for producing shaped bodies, in which
thermally pre-expanded expanded glass with a residual expanding agent content of 0.1 to 1% by mass is placed as granulate in a mould;
subsequently heating to temperatures above the softening temperature of the granulate which leads to a further expansion in volume and to sintering of the granulate surfaces, is implemented and the shaped body is removed from the mould.

4. Method according to claim 3,
characterised in that, before heating, the volume of the mould is filled with the granulate with at least 80% and at most 95%.

5. Method according to claim 3 or 4,
characterised in that the heating is implemented in two stages.

6. Method according to one of the claims 3 to 5,
characterised in that a granulate with particle sizes in the range 0.25 to 8 mm is used.

7. Method according to one of the claims 3 to 6,
characterised in that a thermally pre-expanded expanded glass granulate, which is obtained from recycled glass with the addition of an organic expanding agent, is used.

8. Method according to claim 7,
characterised in that a sugar derivative is used as expanding agent.

9. Method according to claim 7 or 8,
characterised in that the thermal pre-expansion of the lightweight aggregate is implemented such that the residual expanding agent content is produced.
